(19) United States
(12) Patent Application Publication
(10) Pub. No.: US 2024/0299849 A1
(43) Pub. Date: Sep. 12, 2024

(54) CONTROLLING GAME BEHAVIOR OF DEFENSIVE OBJECTIVE CHARACTERS IN A VIRTUAL ENVIRONMENT

(71) Applicant: Bungie, Inc., Bellevue, WA (US)

(72) Inventors: Luke Timmins, Bellevue, WA (US); Gregory Peng, Bellevue, WA (US); Elizabeth M.E. Chung, Bellevue, WA (US); James Lavasseur, Bellevue, WA (US)

(21) Appl. No.: 18/598,556

(22) Filed: Mar. 7, 2024

Related U.S. Application Data
(60) Provisional application No. 63/450,916, filed on Mar. 8, 2023.

(51) Int. Cl. A63F 13/56; A63F 13/67

(52) U.S. Cl. CPC A63F 13/56; A63F 13/67

(57) ABSTRACT

A method for controlling game behavior of defensive objective characters in a virtual environment comprises providing a decision tree including a prioritized set of tasks for a defensive objective character to perform in the virtual environment, each task of the prioritized set of tasks having at least one condition for performing the task, and iteratively modifying the game behavior of the defensive objective character in the virtual environment by processing at least a subset of tasks of the prioritized set of tasks in order of highest priority to lowest priority, wherein processing includes determining whether the at least one condition for a given task of the prioritized set of tasks is satisfied and modifying the game behavior of the defensive objective character in the virtual environment to perform the given task when the at least one condition for the given task is satisfied.

### CROSS-REFERENCE TO RELATED APPLICATIONS

This application claims the benefit of U.S. Provisional Application No. 63/450,916, filed Mar. 8, 2023, for DEFENSIVE OBJECT CHARACTERS, which is fully incorporated herein by reference.

### BACKGROUND

Modern computer and video games employ a variety of techniques to provide engaging victory conditions. Since the advent of early Real Time Strategy (RTS) games, players have been attacking virtual stationary buildings as victory conditions (e.g., “destroy the enemy base to win”). Over time, game logic was added to the objective (e.g., “the enemy base will now shoot at opposing players”) to make the objective harder to capture. The objective mechanic spread to various game genres (e.g., Tower Defense, Multiplayer Online Battle Arena) over decades, but the core mechanic was still basically the same: a stationary objective with “health” that had logic to “guard” a zone. If an enemy, e.g., player or non-player character (NPC), entered the zone to attack the objective, the player or NPC would be attacked. Objectives could be destroyed through attrition (e.g., repeatedly doing damage to the objective, even if the player were killed multiple times in the process), force of numbers (e.g., multiple players attack the objective simultaneously), or through power progression (e.g., the player gets better weapons or “levels up” to do more damage over time).

Unfortunately, these conventional mechanics have become, over time, boring for players, especially when a player is controlling an avatar whose primary attack method is melee. “Boss Enemies” (enemy avatars that players had to learn various mechanics to defeat) have existed in single player games since the 1980s and moved to cooperative games over the last two decades, but these have not been found in player verses player (PvP) experiences. Therefore, improved techniques for engaging players with meaningful victory conditions are of great interest to the gaming industry.

### BRIEF DESCRIPTION OF THE DRAWINGS

Various embodiments in accordance with the present disclosure will be described with reference to the drawings, in which:

FIG. 1 is a schematic diagram of a service environment in which a virtual controller can be used in accordance with various embodiments of the present disclosure;

FIG. 2 is an illustration of a virtual environment in accordance with various embodiments of the present disclosure;

FIG. 3A is a movement tree configured to manage defensive objective characters for use in the virtual environment in accordance with various embodiments of the present disclosure;

FIG. 3B is another movement tree configured to manage defensive objective characters for use in the virtual environment in accordance with various embodiments of the present disclosure;

FIG. 3C is yet another movement tree configured to manage defensive objective characters for use in the virtual environment in accordance with various embodiments of the present disclosure;

FIG. 4 is still another movement tree configured to manage defensive objective characters for use in the virtual environment in accordance with various embodiments of the present disclosure;

FIG. 5 is a flowchart of a method for controlling game behavior of defensive objective characters in the virtual environment in accordance with various embodiments of the present disclosure; and

FIG. 6 is a schematic diagram of an electronic entertainment system in accordance with various embodiments of the present disclosure.

### SUMMARY

According to one aspect, a method is provided for controlling game behavior of defensive objective characters in a virtual environment. The method includes providing a decision tree including a prioritized set of tasks for a defensive objective character to perform in the virtual environment, each task of the prioritized set of tasks having at least one condition for performing the task. The method further includes iteratively modifying the game behavior of the defensive objective character in the virtual environment by processing at least a subset of tasks of the prioritized set of tasks in order of highest priority to lowest priority. Processing the at least a subset of tasks includes determining whether the at least one condition for a given task of the prioritized set of tasks is satisfied and modifying the game behavior of the defensive objective character in the virtual environment to perform the given task when the at least one condition for the given task is satisfied.

In some examples, the defensive objective character includes an avatar controlled by a non-player state machine in the virtual environment.

In some examples, the virtual environment is a player verses player (PvP) video game.

In some examples, processing includes, after the given task is performed, iterating back to a task of the highest priority in the prioritized set of tasks.

In some examples, processing includes, after the given task is performed, iterating to a task of lower priority in the prioritized set of tasks than the given task.

In some examples, the given task creates a new task in the prioritized set of tasks with an associated condition.

In some examples, the given task changes a priority of at least one task in the prioritized set of tasks.

In some examples, the given task changes the at least one condition of at least one task in the prioritized set of tasks.

In some examples, the given task includes a plurality of sub-tasks to be performed when the at least one condition for the given task is satisfied.

In some examples, the at least one condition of the given task includes that the at least one condition for each higher priority task was not satisfied.

In some examples, the at least one condition for performing the given task is that the defensive objective character is frozen, and wherein the given task is to iterate to a next task.

In some examples, the at least one condition for performing the given task is that a special ability of the defensive objective character is charged, and wherein the given task is to use the special ability.

In some examples, the at least one condition for performing the given task is that the defensive objective character is stuck, and wherein the given task is to jump toward a target point.

In some examples, the at least one condition for performing the given task is that the defensive objective character has moved beyond a threshold distance from a guard position, and wherein the given task includes setting a retreating status of the defensive objective character and causing the defensive objective character to move toward the guard position.

In some examples, the at least one condition for performing the given task is that the defensive objective character has the retreating status and is proximate to the guard position, and wherein the given task is to clear the retreating status.

In some examples, the at least one condition for performing the given task is that the defensive objective character is proximate to a target, and wherein the given task is engaging the target.

According to another aspect, a system is provided for controlling game behavior of defensive objective characters in a virtual environment. The system includes at least one processor and at least one memory, the at least one memory storing a decision tree including a prioritized set of tasks for a defensive objective character to perform in the virtual environment, each task of the prioritized set of tasks having at least one condition for performing the task. The at least one memory additionally stores instructions for implementing a selection module that, when executed by the at least one processor, iteratively modifies the game behavior of the defensive objective character in the virtual environment by processing at least a subset of tasks of the prioritized set of tasks in order of highest priority to lowest priority. The selection module processes each task of the at least the subset of tasks by determining whether the at least one condition for a given task of the prioritized set of tasks is satisfied and modifying the game behavior of the defensive objective character in the virtual environment to perform the given task when the at least one condition for the given task is satisfied.

According to yet another aspect, a non-transitory computer-readable medium is provided including instructions that, when executed by one or more processors, cause the one or more processors to perform a method for controlling game behavior of defensive objective characters in a virtual environment. The method includes providing a decision tree including a prioritized set of tasks for a defensive objective character to perform in the virtual environment, each task of the prioritized set of tasks having at least one condition for performing the task. The method further includes iteratively modifying the game behavior of the defensive objective character in the virtual environment by processing at least a subset of tasks of the prioritized set of tasks in order of highest priority to lowest priority. Processing the at least a subset of tasks includes determining whether the at least one condition for a given task of the prioritized set of tasks is satisfied and modifying the game behavior of the defensive objective character in the virtual environment to perform the given task when the at least one condition for the given task is satisfied.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order to not obscure the embodiment being described.

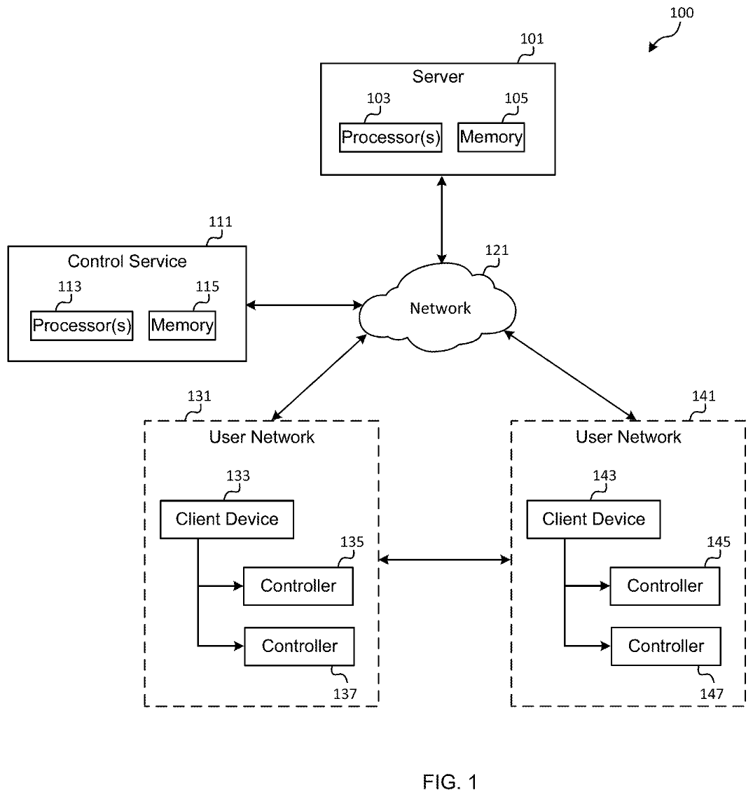

Turning to the figures, FIG. 1 is a simplified system diagram illustrating a service environment 100 in which a virtual controller can be used in accordance with various embodiments of the present disclosure. The service environment 100 includes at least one server 101, which may include at least one processor 103 and at least one non-transitory memory 105 storing software instructions to facilitate operation of the server 101. The server 101 is connected via a network 121, e.g., the Internet or a local area network (LAN), with any suitable number of user-owned client devices 133, 143, which typically operate in conjunction with respective local user networks 131, 141 (e.g., consumer or commercial LANs, Wi-Fi networks, etc.) The server 101 can also connect to any suitable number of control services 111, e.g., network-connected computing systems with their own processor(s) 113 and memory 115 that monitor network traffic to and from the server 101 and client devices 133, 143.

In some embodiments, the server 101 can be one or more servers operating at commercial scale, e.g., a datacenter or server farm. Client devices 133, 143 can include, but are not limited to, consumer personal computers, video game consoles, thin-client devices operable to stream video content from the server 101 for presentation on a local screen, mobile devices, such as smartphones, tablets, and/or the like. Client devices 133, 143 can connect to any suitable number of controllers, e.g., controller 135, 137, 145, 147. The controllers can be hardware devices (e.g., console-specific controllers, cross-compatible controllers, or virtual controllers) with connectivity hardware and protocols for communicating with their respective client devices 133, 143. According to some embodiments, the controller 135 can be a virtualized controller operating on a thin-client device or touch-screen device, e.g., a controller simulated on a touchscreen smartphone, tablet, or console-like controller with a touch-enabled panel. According to some further embodiments, e.g. where the client device 133 is a thin-client device or mobile device, the controller 135 can be a touchscreen with virtualized controls that is built into the client device. Alternatively, even where the client device 133 is a thin-client device, the controller 135 can be a hardware controller configured to physically or wirelessly connect with the client device 133. According to some embodiments, the client device 133 and server 101 can operate on the same hardware, e.g., the client device running as a virtual instance on the server.

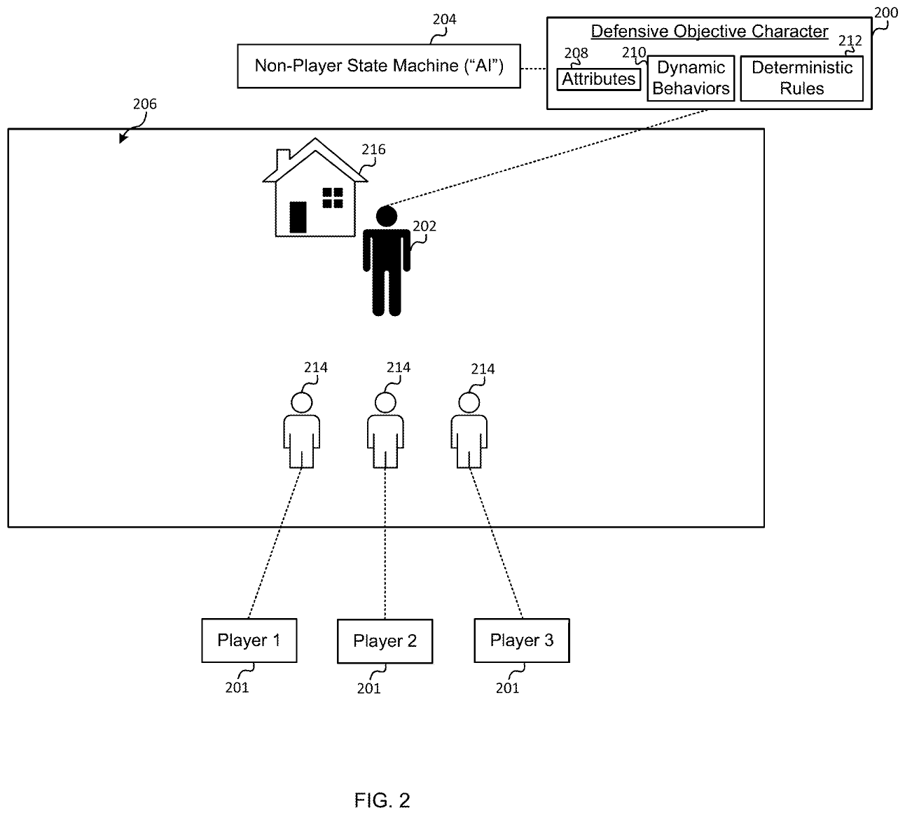

Referring to FIG. 2, embodiments herein are directed to methods and systems for controlling game behavior of at least one defensive objective character 200 for an objective game mode having the same appeal and predictability of a stationary objective that can defend itself, but appears to a player 201 to operate intelligently. As used herein, the defensive objective character 200 is represented by a 2D or 3D avatar 202 controlled by a non-player state machine 204 (aka “AI”) within a virtual environment 206 of a video game, such as a player verses player (PvP) video game. References herein to avatar 202 or defensive objective character 200 may be used interchangeably with the understanding that the avatar 202 is the graphical representation of the defensive objective character 200 within the virtual environment 206.

The defensive objective character 200 may they have attributes 208 (e.g., health, shield), dynamic behaviors 210 (e.g., they walk around, punch, etc.), and deterministic rules 212 (providing predictability). The defensive objective character 200 may also be the objective of the game. In other words, one or more player avatars 214 respectively controlled by one or more players 201 may attempt to kill or otherwise remove the avatar 202 from the virtual environment 206. The defensive objective character 200 may be “defensive” in the sense that it guards a particular position (referred to herein as a guard position 216), which may be near an object, such as a house or castle.

In some technical implementations, “behavior trees” (a technique for complex AI logic) may be used to control the actions of the defensive objective character 200. Briefly, behavior trees are a prioritized set of tasks that can be configured in such a way to result in complex decision making for the defensive objective character 200. Each task is evaluated in priority order from highest priority to lowest priority, and if it can be run, the logic associated with the task (and any sub-tasks in the behavior tree) is executed.

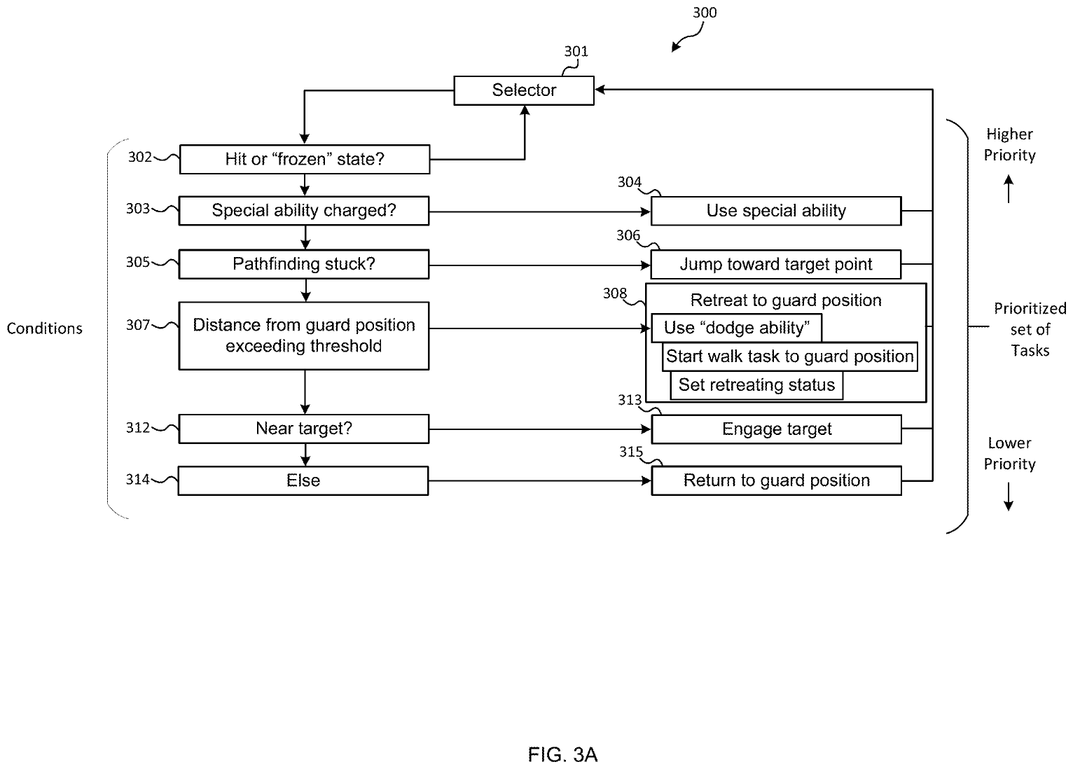

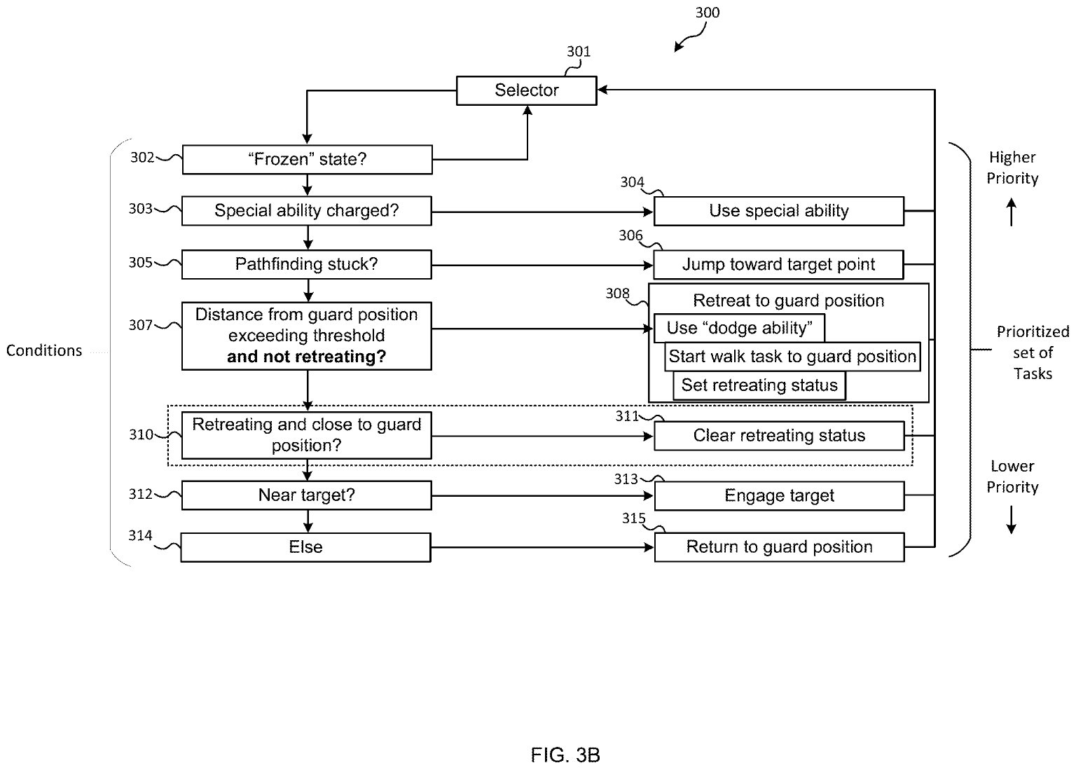

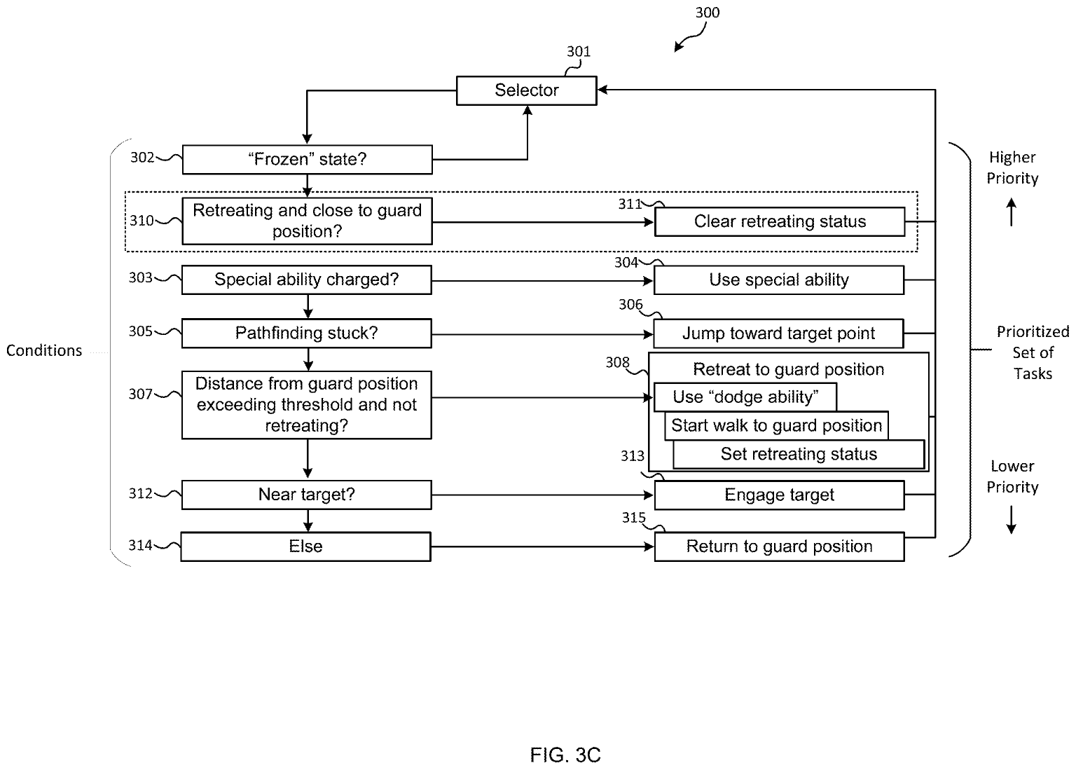

An example behavior tree 300 for a defensive objective character 200 is illustrated in FIG. 3A, though it will be understood that actual behavior trees may contain multiple complex steps and may reorder logic according to context. The advantage of this method is that complex AI logic can be implemented for a multiplayer objective that historically has been simple and static (e.g., “if an enemy enters this zone, fire a projectile at them at this rate”).

As illustrated, a selector 301 (e.g., a selection module for controlling behavior of the defensive objective character 200 in the virtual environment 206 of FIG. 2) iterates through a prioritized set of tasks with associated conditions that can include some or all of the following stages (in priority order, highest to lowest):

At 302, the condition may be that the avatar 202 stops updating/moving due to being recently hit or being in a “frozen” state. If so, the task may be to do nothing and iterate back to 302.

At 303, the condition may be that a “special ability” of the avatar 202 is charged. For example, an avatar 202 can become “enraged” if it has taken too much recent damage, and its special ability is a “stomp” that will “stun” nearby enemies. If the special ability is charged, the associated task at 304 is performed, i.e., use the special ability.

At 305, the condition may be that pathfinding of the avatar 202 is “stuck.” For example, in the case where the avatar 202 is running pathfinding logic to go to a location, if the pathfinding requests fail for a time interval, the avatar may be considered stuck. If so, the associated task at 306 is executed, i.e., the avatar will “jump” to its desired location (e.g., a target point) instead of trying to walk there via pathfinding.

At step 307, the condition may be that the avatar 202 is too far away (e.g., beyond a threshold distance) from its guard position 216. If so, the task at 308 is executed, i.e., retreat to the guard position 216. In this case, the task may have multiple sub-tasks that are executed in response to the condition at 307 being satisfied. For example, the avatar 202 may trigger a “dodge ability” in the direction of its guard position 216. The avatar 202 may wait for the “dodge ability” to finish, after which a new task is started to walk to the guard position 216 using pathfinding (i.e., cause the avatar 202 to move toward the guard position). In addition, a value may be set in the “memory” of the avatar 202 (using, for example, a “blackboard” implementation). A blackboard is a simple place where data can be written and read for decision making purposes. A blackboard can be used by a single AI pawn, shared by a squad, or used for any other purpose where it is convenient to have a central location to look up relevant data.

In one embodiment, the sub-task of “start a walk task to the guard position” may create a new task and associated condition. For example, as shown in FIG. 3B, a new condition at 310 may be that the avatar 202 has a “retreating” status and is proximate (close) to its guard position 216. If so, the associated task at 311 may be performed, i.e., clear the “retreating” status.

In some embodiments, the sub-task to walk to the guard position at 308 may change the condition for performing a task in the prioritized set of tasks. For example, as shown in FIG. 3B, the condition at 307 may be modified to add “and not retreating” to the condition. In certain embodiments, a task can change the priority of a task. For example, as shown in FIG. 3C, the condition at 310 and the corresponding task at 311 may be given a higher priority.

At 310, if the avatar 202 is “retreating” and still far from the guard position at 310, the selector 301 may continue looping at 310, checking if the avatar 202 is proximate to its guard position 216. When the avatar 202 is proximate to the guard position 216, the task of clearing the “retreating” value may be performed at 311.

At 312, the condition may be that the avatar 202 is near an enemy target (e.g., one of the player avatars 214). For example, enemies may be flagged as targets using a “perception” system, in which a test is performed, e.g., a radius and/or angle test, of other avatars that are considered “on the enemy team”). If the avatar 202 is near an enemy target, the task at 313 may be to engage the target. The task may have sub-tasks (not shown), such as issuing a movement task to approach the enemy avatar, waiting for the avatar 202 to get close enough to attack, and if the avatar 202 is close enough to attack the enemy, stop moving, rotate to face the enemy, and attack the enemy. A new task and corresponding condition (not shown) might be created, i.e., if the enemy is too far away to attack, issue a move task to return to the guard position 216.

Finally, and only if all the above tasks do not run at 314 (i.e., the conditions at 303, 305, 307, 310, and 312 are not satisfied), the task at 315 may be to return to the guard position 216.

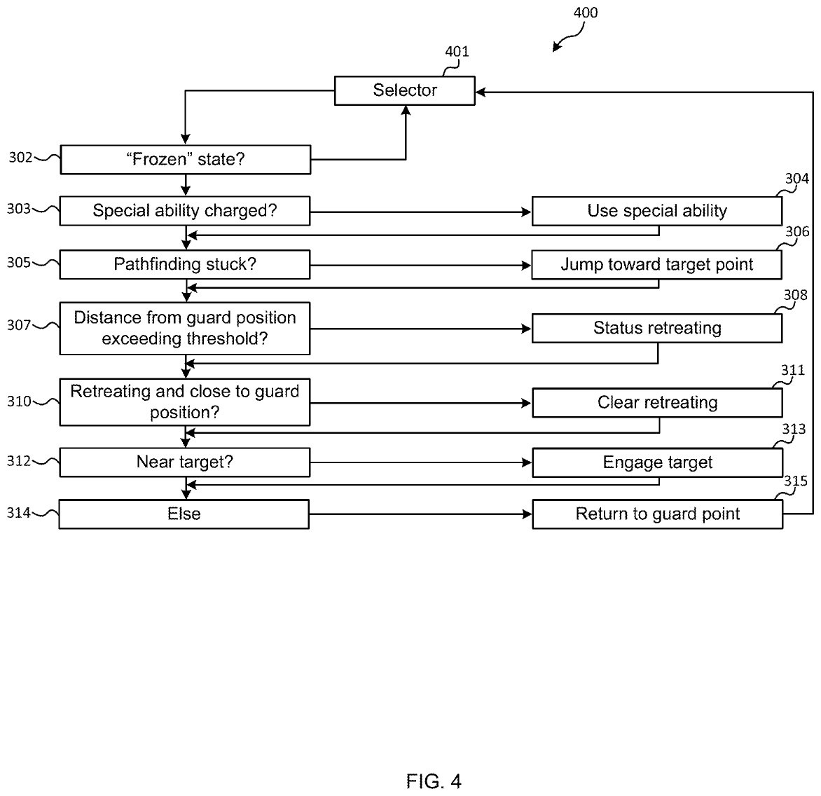

FIGS. 3A-3C all have the common feature that, after the given task is performed, the selector 301 iterates back to the task of highest priority in the prioritized set of tasks. However, FIG. 4 is an example of a behavior tree 400 for a defensive objective character 200 that has similar conditions and tasks to those discussed above, but the behavior tree is configured such that, after a given task is performed, the selector 401 moves to a task of lower priority in the prioritized set of tasks than the given task (i.e., the next task in the decision tree 400), which will produce a different set of behaviors for the defensive objective character 200.

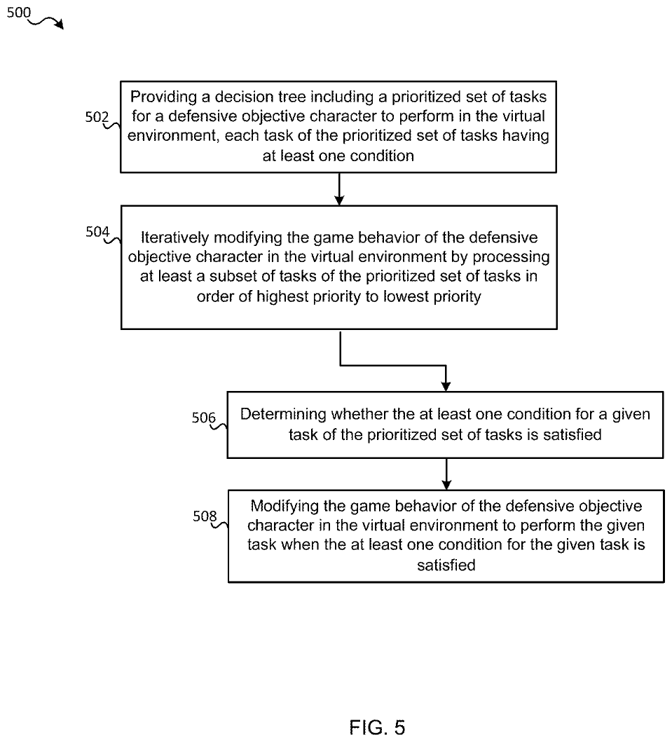

FIG. 5 is a flowchart of a method 500 for controlling game behavior of defensive objective characters in a virtual environment. The method 500 may begin by providing 502 a decision tree including a prioritized set of tasks for a defensive objective character to perform in the virtual environment, each task of the prioritized set of tasks having at least one condition for performing the task.

The method 500 may continue by iteratively modifying 504 the game behavior of the defensive objective character in the virtual environment by processing at least a subset of tasks of the prioritized set of tasks in order of highest priority to lowest priority. In some embodiments, processing the at least a subset of tasks of the prioritized set of tasks may include determining 506 whether the at least one condition for a given task of the prioritized set of tasks is satisfied and modifying 508 the game behavior of the defensive objective character in the virtual environment to perform the given task when the at least one condition for the given task is satisfied.

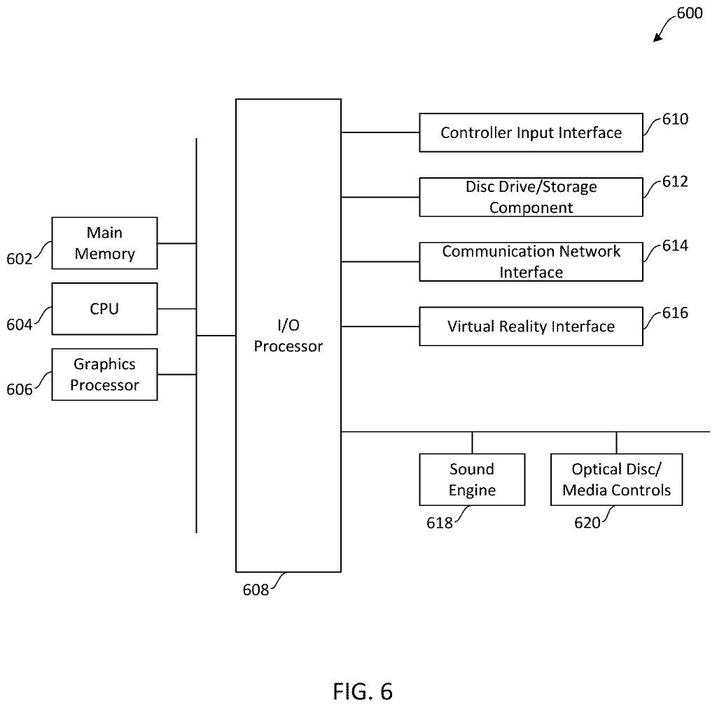

Each of the client devices 133, 143 of FIG. 1 may be embodied as an electronic entertainment system 600, such as an electronic game console, as shown in FIG. 6. The electronic entertainment system 600 may alternatively be implemented as a general-purpose computer, a set-top box, a hand-held game device, a tablet computing device, or a mobile computing device or phone. Electronic entertainment systems 600 may contain some or all of the disclosed components depending on a particular form factor, purpose, or design.

Main memory 602 stores instructions and data for execution by CPU 604. Main memory 602 can store executable code when the electronic entertainment system 600 is in operation. Main memory 602 of FIG. 6 may communicate with CPU 604 via a dedicated bus. Main memory 602 may provide pre-stored programs in addition to programs transferred through the I/O processor 608 from hard disc drive/storage component 612, a DVD or other optical disc (not shown) using the optical disc/media controls 620, or as might be downloaded via communication network interface 614.

The graphics processor 606 of FIG. 6 (or graphics card) executes graphics instructions received from the CPU 604 to produce images for display on a display device (not shown). The graphics processor 606 of FIG. 6 may transform objects from three-dimensional coordinates to two-dimensional coordinates, and vice versa. Graphics processor 606 may use ray tracing to aid in the rendering of light and shadows in a game scene by simulating and tracking individual rays of light produced by a source. Graphics processor 606 may utilize fast boot and load times, 4K-8K resolution, and up to 120 FPS with 120 hz refresh rates. Graphics processor 606 may render or otherwise process images differently for a specific display device.

I/O processor 608 of FIG. 6 may also allow for the exchange of content over a wireless or other communications network (e.g., IEEE 802.x inclusive of Wi-Fi and Ethernet, 5G, 4G, LTE, and 3G mobile networks, and Bluetooth and short-range personal area networks). The I/O processor 608 of FIG. 6 controls data exchanges between the various devices of the electronic entertainment system 600 including the CPU 604, the graphics processor 606, controller interface 610, hard disc drive/storage component 612, communication network interface 614, virtual reality interface 616, sound engine 618, and optical disc/media controls 620.

A user of the electronic entertainment system 600 of FIG. 6 provides instructions via a controller device communicatively coupled to the controller interface 610 to the CPU 604. A variety of different controllers may be used to receive the instructions, including handheld and sensor-based controllers (e.g., for capturing and interpreting eye-tracking-based, voice-based, and gestural commands). Controllers may receive instructions or input from the user, which may then be provided to controller interface 610 and then to CPU 604 for interpretation and execution. The instructions may further be used by the CPU 604 to control other components of electronic entertainment system 600. For example, the user may instruct the CPU 604 to store certain game information on the hard disc drive/storage component 612 or other non-transitory computer-readable storage media. A user may also instruct a character in a game to perform some specified action, which is rendered in conjunction with graphics processor 606, inclusive of audio interpreted by sound engine 618.

Hard disc drive/storage component 612 may include removable or non-removable non-volatile storage medium. Such medium may be portable and inclusive of digital video disc, Blu-Ray, or USB coupled storage, to input and output data and code to and from the main memory 602. Software for implementing embodiments of the present invention may be stored on such a medium and input to the main memory 602 via the hard disc drive/storage component 612. Software stored on a hard disc drive may also be managed by optical disk/media control 620 and/or communication network interface 614.

Communication network interface 614 may allow for communication via various communication networks, including local, proprietary networks and/or larger wide-area networks such as the Internet. The Internet is a broad network of interconnected computers and servers allowing for the transmission and exchange of Internet Protocol (IP) data between users connected through a network service provider. Examples of network service providers include public switched telephone networks, cable or fiber services, digital subscriber lines (DSL) or broadband, and satellite services. Communications network interface allows for communications and content to be exchanged between the various remote devices, including other electronic entertainment systems associated with other users and cloud-based databases, services and servers, and content hosting systems that might provide or facilitate game play and related content.

Virtual reality interface 616 allows for processing and rendering of virtual reality, augmented reality, and mixed reality data. This includes display devices that might be partial or entirely immersive virtual environments. Virtual reality interface 616 may allow for exchange and presentation of immersive fields of view and foveated rendering in coordination with sounds processed by sound engine 618 and haptic feedback.

Sound engine 618 executes instructions to produce sound signals that are outputted to an audio device such as television speakers, controller speakers, stand-alone speakers, headphones, or other head-mounted speakers. Different sets of sounds may be produced for each of the different sound output devices. This may include spatial or three-dimensional audio effects.

Optical disc/media controls 620 may be implemented with a magnetic disk drive or an optical disk drive for storing, managing, and controlling data and instructions for use by CPU 604. Optical disc/media controls 620 may be inclusive of system software (an operating system) for implementing embodiments of the present disclosure. That system may facilitate loading software into main memory 602.

The various embodiments further can be implemented in a wide variety of operating environments, which in some cases can include one or more user computers, computing devices or processing devices, which can be used to operate any of several applications. User or client devices can include any number of general-purpose personal computers, such as desktop or laptop computers running a standard operating system, as well as cellular, wireless and handheld devices running mobile software and capable of supporting a number of networking and messaging protocols. Such a system also can include one or more workstations running any of a variety of commercially available operating systems and other known applications for purposes such as development and database management. These devices also can include other electronic devices, such as dummy terminals, thin-clients, gaming systems and other devices capable of communicating via a network. Most embodiments utilize at least one network that would be familiar to those skilled in the art for supporting communications using any of a variety of commercially available protocols, such as Transmission Control Protocol/Internet Protocol (“TCP/IP”), Open System Interconnection (“OSI”), File Transfer Protocol (“FTP”), Universal Plug and Play (“UPnP”), Network File System (“NFS”), Common Internet File System (“CIFS”) and AppleTalk. The network can be, for example, a local area network, a wide-area network, a virtual private network, the Internet, an intranet, an extranet, a public switched telephone network, an infrared network, a wireless network, and/or any combination thereof.

In embodiments utilizing a Web server, the Web server can run any of a variety of server or mid-tier applications, including Hypertext Transfer Protocol (“HTTP”) servers, FTP servers, Common Gateway Interface (“CGI”) servers, data servers, Java servers and business application servers. The server(s) also may be capable of executing programs or scripts in response to requests from user devices, such as by executing one or more Web applications that may be implemented as one or more scripts or programs written in any programming language, such as Java®, C, C# or C++, or any scripting language, such as Perl, Python or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen or keypad) and at least one output device (e.g., a display device, printer or speaker). Such a system may also include one or more storage devices, such as disk drives, optical storage devices and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card, an infrared communication device, etc.) and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the a system device. Based at least in part on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this disclosure are described herein, including the best mode known to the inventors for carrying out the invention. Variations of those preferred embodiments may become apparent to those of ordinary skill in the art upon reading the foregoing description. The inventors expect skilled artisans to employ such variations as appropriate and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for controlling game behavior of defensive objective characters in a virtual environment, the method comprising:
providing a decision tree including a prioritized set of tasks for a defensive objective character to perform in the virtual environment, each task of the prioritized set of tasks having at least one condition for performing the task; and
iteratively modifying the game behavior of the defensive objective character in the virtual environment by processing at least a subset of tasks of the prioritized set of tasks in order of highest priority to lowest priority, wherein processing includes:
determining whether the at least one condition for a given task of the prioritized set of tasks is satisfied; and
modifying the game behavior of the defensive objective character in the virtual environment to perform the given task when the at least one condition for the given task is satisfied.

2. The method of claim 1, wherein the defensive objective character includes an avatar controlled by a non-player state machine in the virtual environment.

3. The method of claim 1, wherein the virtual environment is a player verses player (PvP) video game.

4. The method of claim 1, wherein processing includes, after the given task is performed, iterating back to a task of the highest priority in the prioritized set of tasks.

5. The method of claim 1, wherein processing includes, after the given task is performed, iterating to a task of lower priority in the prioritized set of tasks than the given task.

6. The method of claim 1, wherein the given task creates a new task in the prioritized set of tasks with an associated condition.

7. The method of claim 1, wherein the given task changes a priority of at least one task in the prioritized set of tasks.

8. The method of claim 1, wherein the given task changes the at least one condition of at least one task in the prioritized set of tasks.

9. The method of claim 1, wherein the given task includes a plurality of sub-tasks to be performed when the at least one condition for the given task is satisfied.

10. The method of claim 1, wherein the at least one condition of the given task includes that the at least one condition for each higher priority task was not satisfied.

11. The method of claim 1, wherein the at least one condition for performing the given task is that the defensive objective character is frozen, and wherein the given task is to iterate to a next task.

12. The method of claim 11, wherein the at least one condition for performing the given task is that a special ability of the defensive objective character is charged, and wherein the given task is to use the special ability.

13. The method of claim 12, wherein the at least one condition for performing the given task is that the defensive objective character is stuck, and wherein the given task is to jump toward a target point.

14. The method of claim 13, wherein the at least one condition for performing the given task is that the defensive objective character has moved beyond a threshold distance from a guard position, and wherein the given task includes:
setting a retreating status of the defensive objective character; and
causing the defensive objective character to move toward the guard position.

15. The method of claim 14, wherein the at least one condition for performing the given task is that the defensive objective character has the retreating status and is close to the guard position, and wherein the given task is to clear the retreating status.

16. The method of claim 15, wherein the at least one condition for performing the given task is that the defensive objective character is proximate to a target, and wherein the given task is engaging the target.

17. A system for controlling game behavior of defensive objective characters in a virtual environment, the system comprising:
at least one processor; and
at least one memory storing a decision tree including a prioritized set of tasks for a defensive objective character to perform in the virtual environment, each task of the prioritized set of tasks having at least one condition for performing the task;
wherein the at least one memory stores instructions for implementing a selection module that, when executed by the at least one processor, iteratively modifies the game behavior of the defensive objective character in the virtual environment by processing at least a subset of tasks of the prioritized set of tasks in order of highest priority to lowest priority, wherein the selection module processes each task of the at least the subset of tasks by:
determining whether the at least one condition for a given task of the prioritized set of tasks is satisfied; and
modifying the game behavior of the defensive objective character in the virtual environment to perform the given task when the at least one condition for the given task is satisfied.

18. The system of claim 17, wherein the defensive objective character includes an avatar controlled by a non-player state machine in the virtual environment, and wherein the virtual environment is a player verses player (PvP) video game.

19. The system of claim 17, wherein processing by the selection module includes, after the given task is performed, iterating back to a task of the highest priority in the prioritized set of tasks.

20. The system of claim 17, wherein processing by the selection module includes, after the given task is performed, iterating to a task of lower priority in the prioritized set of tasks than the given task.

21. The system of claim 17, wherein the given task creates a new task in the prioritized set of tasks with an associated condition.

22. The system of claim 17, wherein the given task changes a priority of at least one task in the prioritized set of tasks.

23. The system of claim 17, wherein the given task changes the at least one condition of at least one task in the prioritized set of tasks.

24. The system of claim 17, wherein the given task includes a plurality of sub-tasks to be performed when the at least one condition for the given task is satisfied.

25. A non-transitory computer-readable medium storing program code that, when executed by one or more processors, cause the one or more processors to perform a method for controlling game behavior of defensive objective characters in a virtual environment, the method comprising:
providing a decision tree including a prioritized set of tasks for a defensive objective character to perform in the virtual environment, each task of the prioritized set of tasks having at least one condition for performing the task; and
iteratively modifying the game behavior of the defensive objective character in the virtual environment by processing at least a subset of tasks of the prioritized set of tasks in order of highest priority to lowest priority, wherein processing includes:
determining whether the at least one condition for a given task of the prioritized set of tasks is satisfied; and
modifying the game behavior of the defensive objective character in the virtual environment to perform the given task when the at least one condition for the given task is satisfied.
